(19) United States
(12) Patent Application Publication
(10) Pub. No.: US 2001/0000548 A1
(43) Pub. Date: May 3, 2001

(54) Post protection system

(76) Inventor: Keith A. Niehaus, Clarksville, IA (US)

Correspondence Address: Michael S. Neustel, 2534 South University Drive, Suite, No. 4, Fargo, ND, 58103, US

(21) Appl. No.: 09/728,358

(22) Filed: Dec. 1, 2000

Related U.S. Application Data
(63) Continuation of application No. 08/987,699, filed on Dec. 9, 1997, now abandoned.

(51) Int. Cl. B23P 11/02

(52) U.S. Cl. 29/450

(57) ABSTRACT

A post protection system for extending the useful life of wooden posts positioned below ground level. The post protection system includes an elongate sleeve having a plurality of side walls, an upper opening, a floor and an interior cavity. A plurality of vertical ribs extend inwardly from the side walls toward the interior cavity for engaging the outside surface of the wooden post. A seal is positionable about the upper end of the sleeve for enclosing the upper opening with the wooden post positioned within. Ventilation into the interior cavity is allowed about the lower end of the seal through the grooves created by the vertical ribs while still allowing the seal to prevent rain from entering the upper portion thereof. A plurality of extended members extend from the lower portion of the sleeve for retaining the sleeve properly positioned during ground freezing and various other conditions that tend to apply an upward force upon the sleeve.

### CROSS-REFERENCE TO RELATED U.S. PATENT APPLICATIONS

1. I hereby claim benefit under Title 35, United States Code, Section 120 of U.S. patent application Ser. No. 08/987,699 filed Dec. 9, 1997 and refilled as a divisional/continuation patent application Ser. No. 08/987,699 filed on Mar. 26, 1999. This application is a continuation-in-part of the 08/987,699 application. The 08/987,699 application is currently pending. The 08/987,699 application is hereby incorporated by reference into this application.

### BACKGROUND OF THE INVENTION

2. 1. Field of the Invention

3. The present invention relates generally to post protection devices and more specifically it relates to a post protection system for extending the useful life of wooden posts positioned below ground level.

4. Wooden posts have been in use for many years for various applications such as but not limited fencing and building supports. The deterioration of wooden posts positioned beneath the ground surface is well known in the art. The portion of the wooden posts positioned beneath the surface of the ground often times deteriorate due to rotting or insects.

5. Manufacturers of wooden posts that are to be inserted below the ground surface often times treat the wood with preservatives to reduce rotting caused by moisture and direct ground contact. The utilization of chemical treatments to preserve the wooden post is often times not desirable for environmental reasons. Even with treatment by preservatives, the effectiveness of the preservatives eventually weakens over time leading to the eventual deterioration of the wooden post. Chemical preservatives are therefore not a preferable nor reliable system for protecting the lower portion of a wooden post.

6. 2. Description of the Prior Art

7. Another type of protection system utilized to protect the lower portions of wooden posts inserted below the ground surface is to utilize a “sleeve” that surrounds the lower portion of the post thereby reducing direct contact of the wooden post with the surrounding ground. These conventional types of sleeve protectors typically are comprised of four flat walls and a floor defining an elongate interior cavity within that receives the wooden post.

8. A significant problem with conventional sleeve protection devices is that they are not suitable for usage upon wooden posts with varying widths that are commonly encountered because of the manufacturing of the wooden posts and swelling/shrinking of the wooden post dependent upon moisture content. If the wooden post is larger than the upper opening and interior cavity of a conventional sleeve protector the wooden post has to be reduced in size by cutting which is time consuming and costly.

9. Another problem with conventional sleeve protection devices is that they allow moisture to seep through the upper opening of the sleeve protection device and around the wooden post since there is no seal. In addition, insects are allowed to enter the interior portion of the sleeve protector about the outer portion of the wooden post within recessed areas upon the wooden post. To solve this problem many wooden post installers utilize an impermeable sealant such as but not limited to caulking about the upper end of the sleeve protector and the wooden post. However, an impermeable sealant simply results in condensation to occur within the interior cavity of the sleeve about the wooden post that results in the deterioration of the wooden post due to rotting. An impermeable sealant does not provide adequate ventilation of the interior cavity of the protective sleeve. In addition, utilizing a liquid sealant is time consuming and costly to install about each wooden post.

10. Another problem with conventional protective sleeves is that they often times are heaved from the ground over extended periods of time when positioned within cold weather environment where ground freezing occurs. Since the outer surface of the protective sleeve is typically relatively smooth as they are typically manufactured from plastic or metal there is little resistance to terminate the upward movement of the protective sleeve during ground freezing.

11. An exemplary example of the prior art protective sleeves is shown in U.S. Pat. No. 5,315,796 to Gruhlke. Gruhlke teaches a tubular structure having an enclosed lower end and a pair of V-shaped vents extending longitudinally along the walls of the tubular structure. However, Gruhlke does not teach a protective sleeve system that has an adequate seal structure for sealing the upper opening from water. In addition, Gruhlke does not teach a protective sleeve system that adequately receives wooden posts of varying sizes caused by imperfect manufacturing, swelling or shrinking. Also, Gruhlke does not teach a protective sleeve system that is not susceptible to uplift caused by ground freezing or other forces. In addition, Gruhlke does not teach a protective sleeve system that adequately centers a post within the sleeve structure. All of the limitations of Gruhlke are found within the prior art. Hence, there is a need for a post protection system that provides a solution to the problems of Gruhlke and the prior art.

12. While these devices may be suitable for the particular purpose to which they address, they are not as suitable for extending the useful life of wooden posts positioned below ground level. Conventional protective sleeves are not suitable for protecting the lower portion of a wooden post from moisture and insects. Conventional protective sleeves also require significant amounts of time and labor to adequately install a wooden post within the ground.

13. In these respects, the post protection system according to the present invention substantially departs from the conventional concepts and designs of the prior art, and in so doing provides an apparatus primarily developed for the purpose of extending the useful life of wooden posts positioned below ground level.

### SUMMARY OF THE INVENTION

14. In view of the foregoing disadvantages inherent in the known types of post protector devices now present in the prior art, the present invention provides a new post protection system construction wherein the same can be utilized for extending the useful life of wooden posts positioned below ground level.

15. The general purpose of the present invention, which will be described subsequently in greater detail, is to provide a new post protection system that has many of the advantages of the post protector devices mentioned heretofore and many novel features that result in a new post protection system which is not anticipated, rendered obvious, suggested, or even implied by any of the prior art post protector devices, either alone or in any combination thereof.

16. To attain this, the present invention generally comprises an elongate sleeve having a plurality of side walls, an upper opening, a floor and an interior cavity. A plurality of vertical ribs extend inwardly from the side walls toward the interior cavity for engaging the outside surface of the wooden post. A seal is positionable about the upper end of the sleeve for enclosing the upper opening with the wooden post positioned within. Ventilation into the interior cavity is allowed about the lower end of the seal through the grooves created by the vertical ribs while still allowing the seal to prevent rain from entering the upper portion thereof. A plurality of extended members extend from the lower portion of the sleeve for retaining the sleeve properly positioned during ground freezing and various other conditions that tend to apply an upward force upon the sleeve.

17. There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

18. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

19. A primary object of the present invention is to provide a post protection system that will overcome the shortcomings of the prior art devices.

20. A second object is to provide a post protection system for extending the useful life of wooden posts positioned below ground level.

21. Another object is to provide a post protection system that is easy and simple to install for most users.

22. An additional object is to provide a post protection system that does not require significant amount of time and labor to install a wooden post within the ground.

23. A further object is to provide a post protection system that retains the lower portion of a wooden post relatively free of moisture thereby reducing the deterioration of the wooden post due to moisture.

24. Another object is to provide a post protection system that provides adequate ventilation about the lower portion of a wooden post to allow drying of moisture contained within the wooden post.

25. A further object is to provide a post protection system that receives various sizes of wooden posts regardless of inaccurate manufacturing, swelling or shrinking.

26. Another object is to provide a post protection system that protects a wooden post without the usage of chemical preservatives.

27. An additional object is to provide a post protection system that is not susceptible to removal from the ground due to wind, frost, ground freezing or other forces.

28. A further object is to provide a post protection system that is waterproof yet ventilated.

29. Another object is to provide a post protection system that fits various sizes of wooden posts such as but not limited to 4×4, 4×6 or 6×6 and also laminated columns of various sizes.

30. Other objects and advantages of the present invention will become obvious to the reader and it is intended that these objects and advantages are within the scope of the present invention.

31. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

32. Various other objects, features and attendant advantages of the present invention will become fully appreciated as the same becomes better understood when considered in conjunction with the accompanying drawings, in which like reference characters designate the same or similar parts throughout the several views, and wherein:

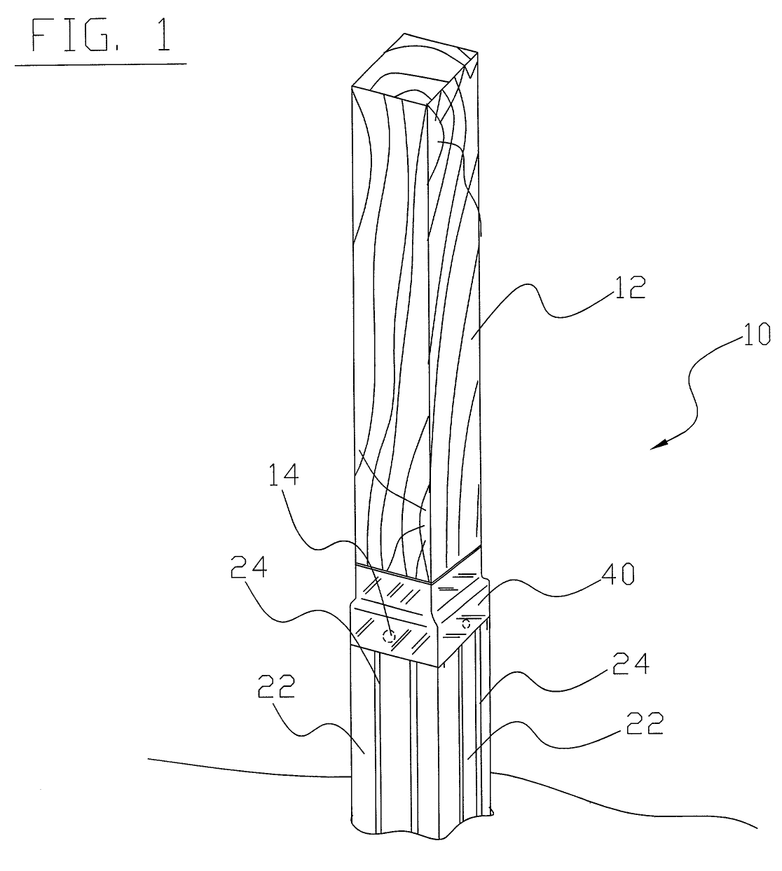

33. FIG. 1 is an upper perspective view of the present invention with a wooden post retained within positioned within a ground surface.

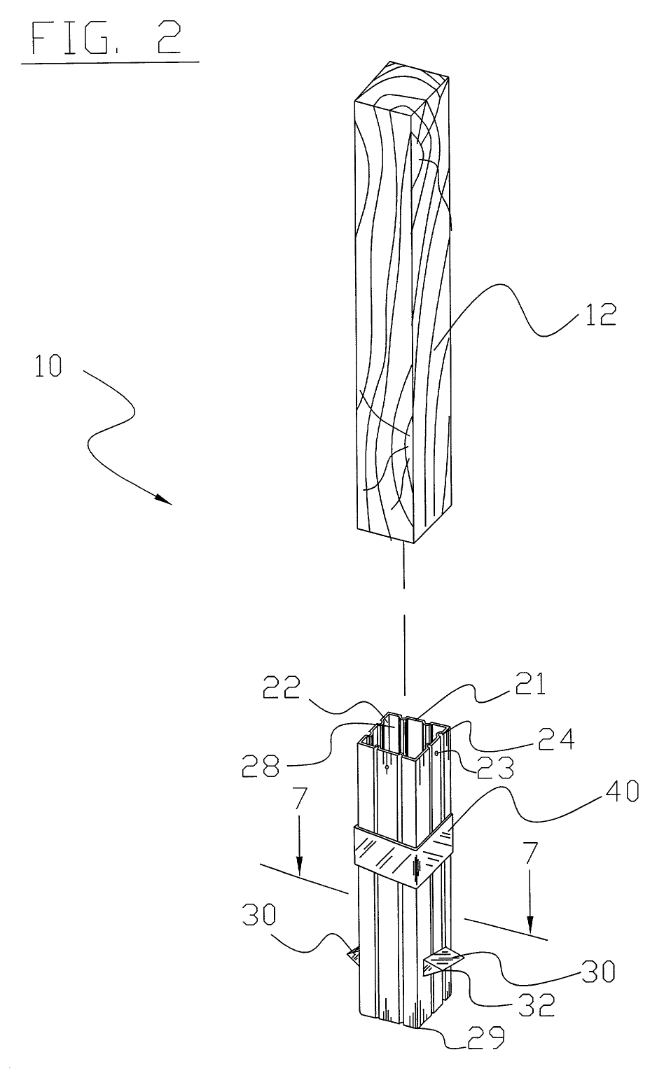

34. FIG. 2 is an exploded upper perspective view of the present invention with respect to a wooden post.

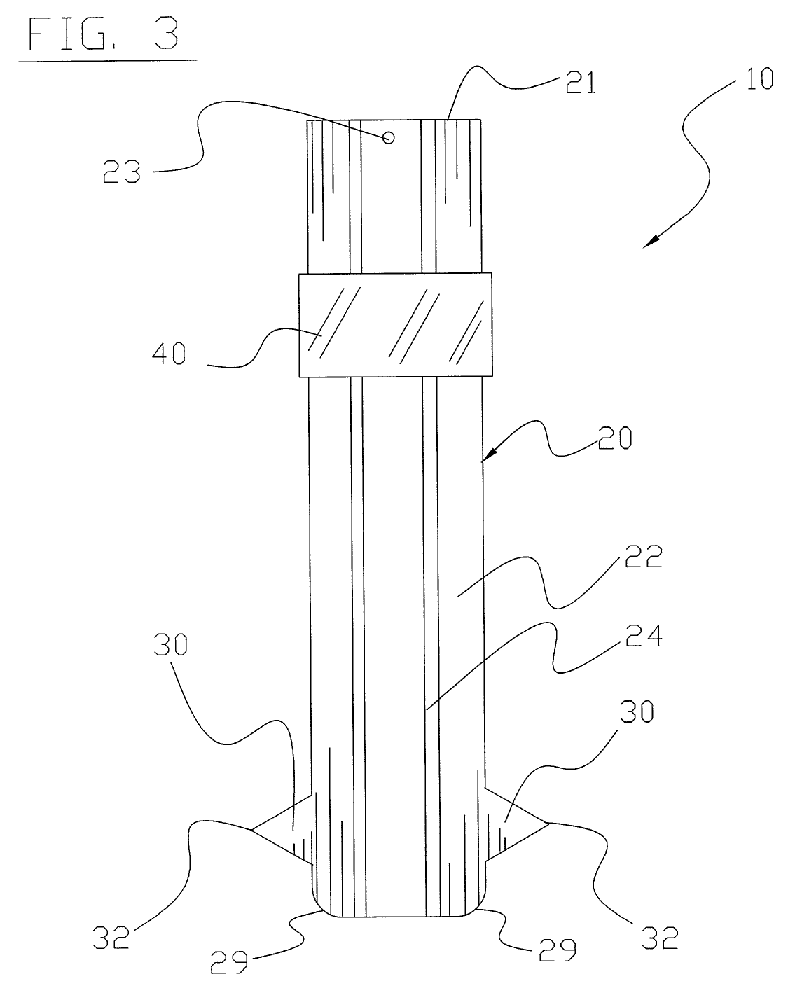

35. FIG. 3 is a side view of the present invention with the seal lowered about the sleeve.

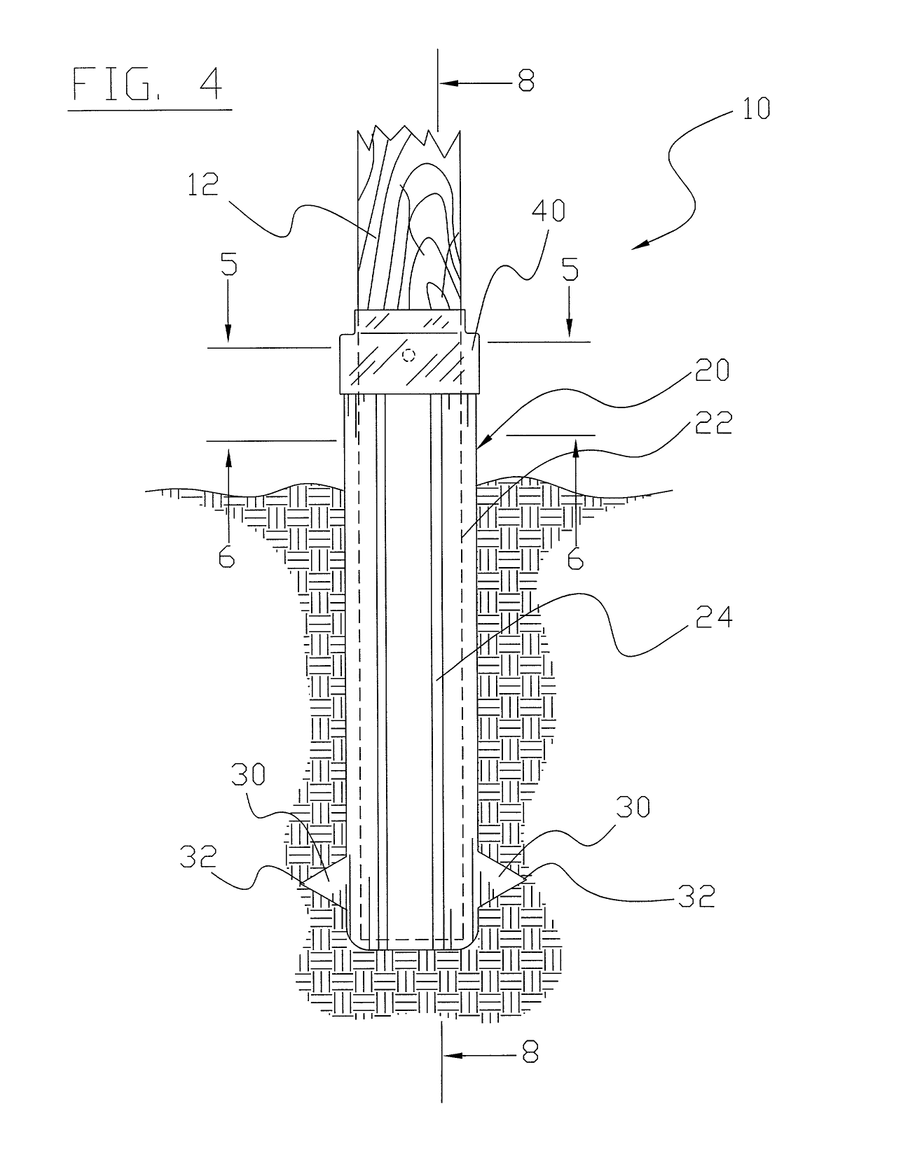

36. FIG. 4 is a side view of the present invention with a wooden posted retained within positioned within the ground.

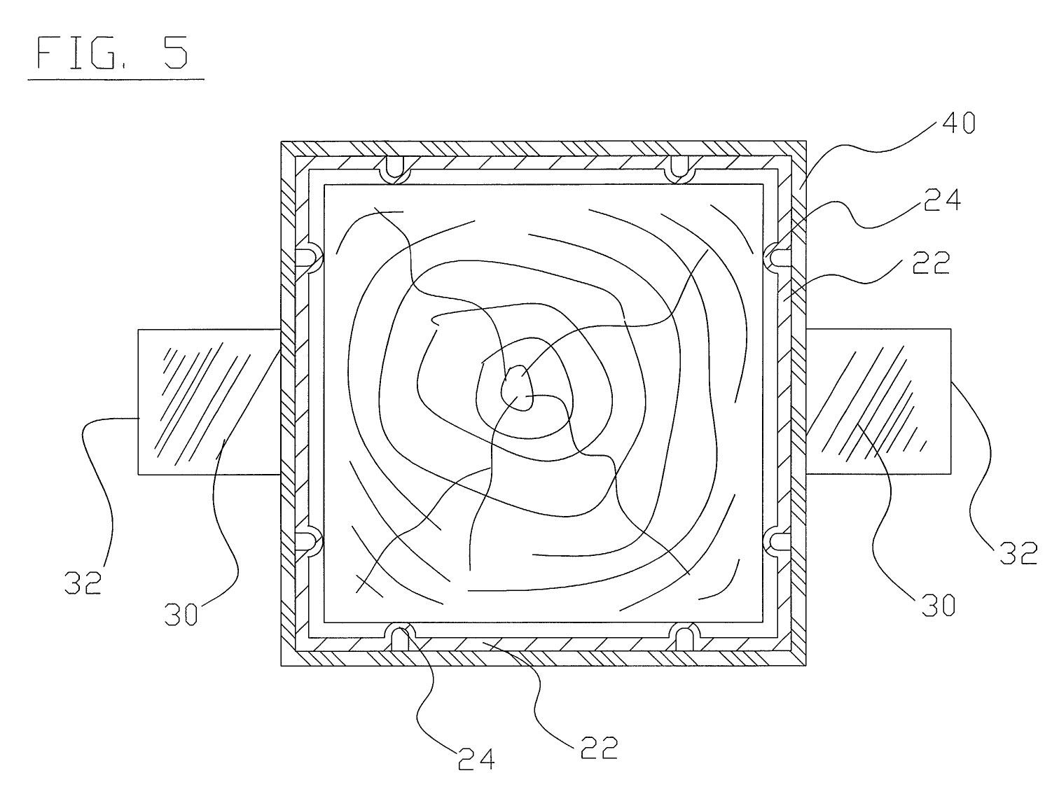

37. FIG. 5 is a cross sectional view taken along line 5—5 of FIG. 4 of the drawings.

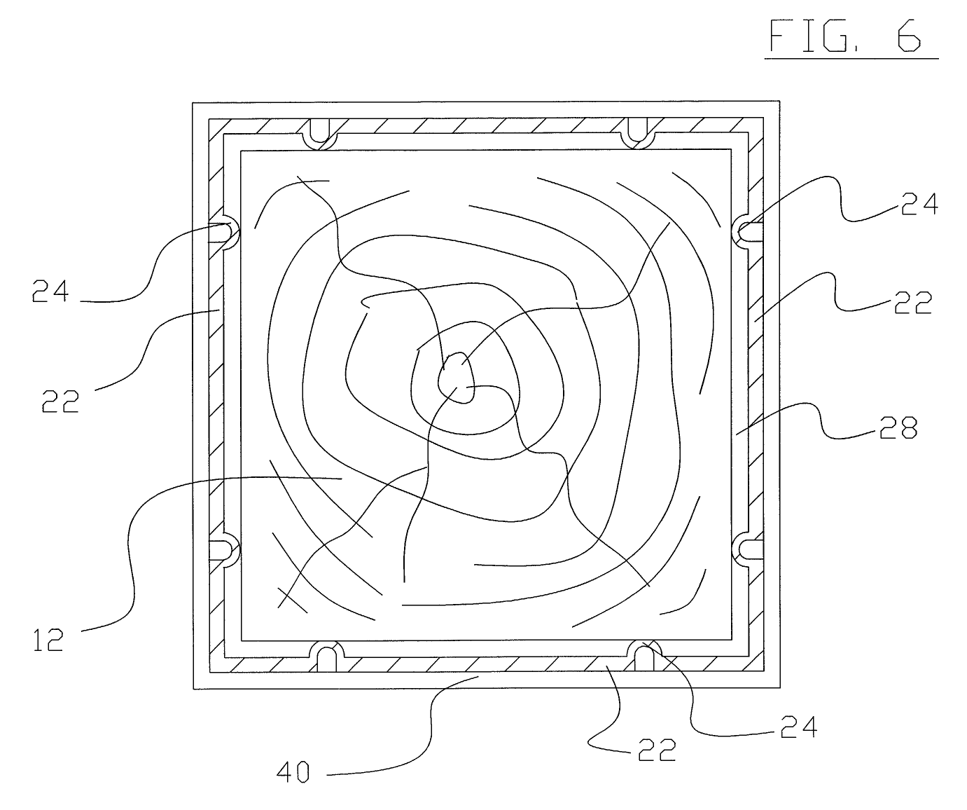

38. FIG. 6 is a cross sectional view taken along line 6—6 of FIG. 4 of the drawings.

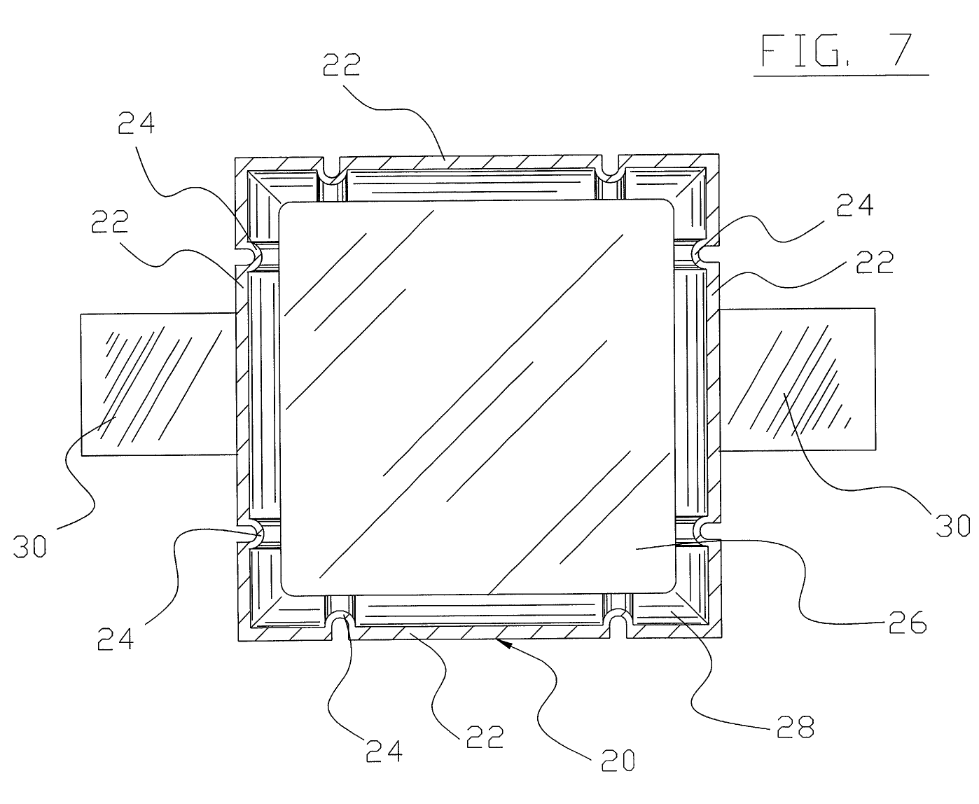

39. FIG. 7 is a cross sectional view taken along line 7—7 of FIG. 2 of the drawings.

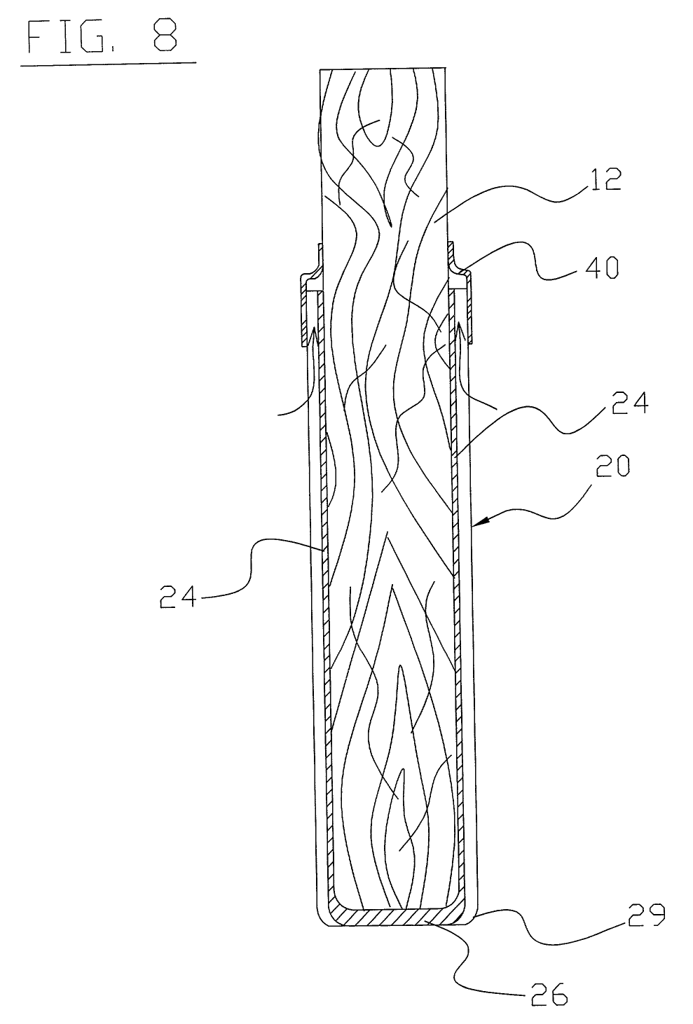

40. FIG. 8 is a cross sectional view taken along line 8—8 of FIG. 4 of the drawings.

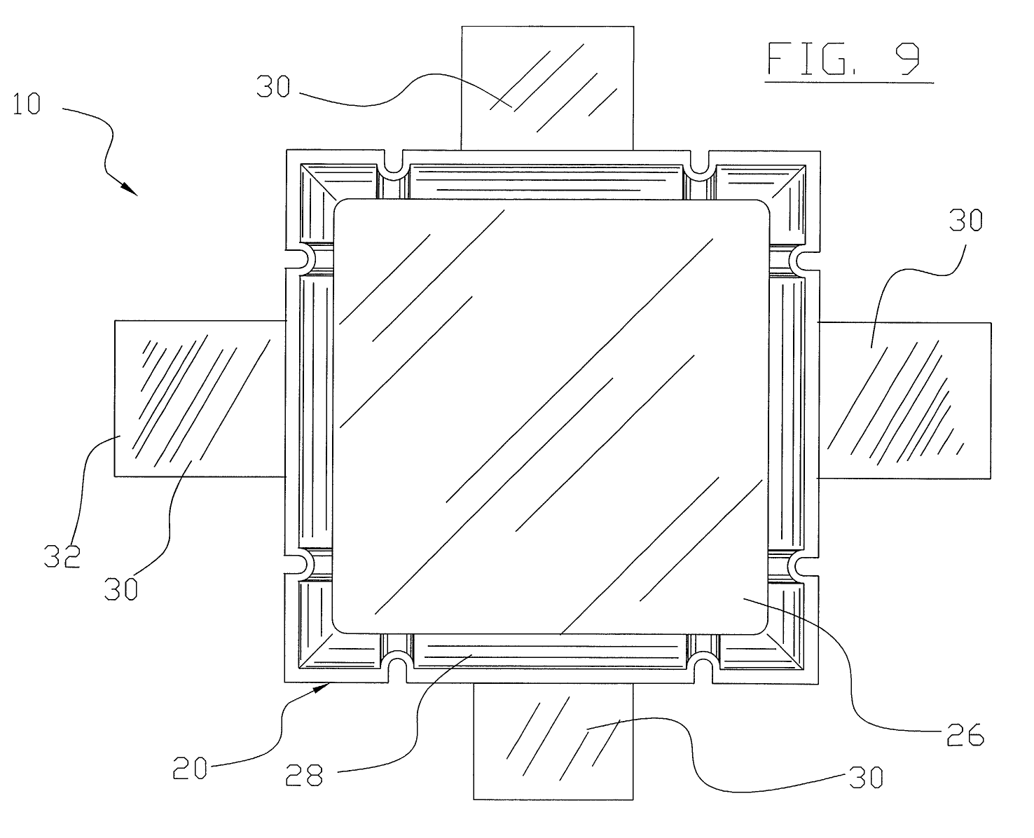

41. FIG. 9 is a top view of the present invention.

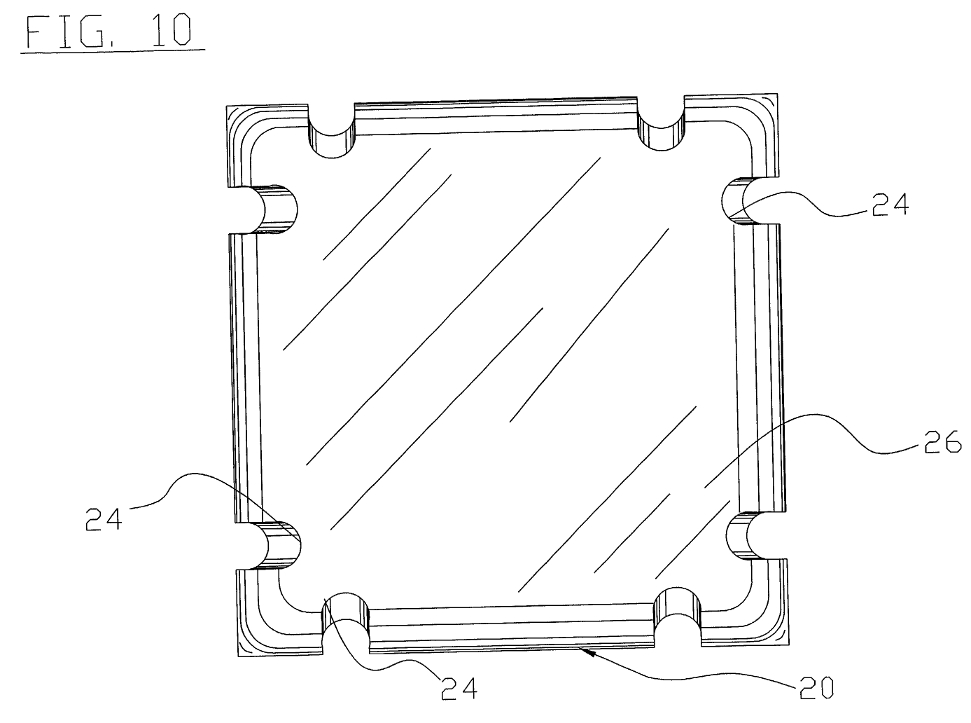

42. FIG. 10 is a bottom view of the present invention.

### DESCRIPTION OF THE PREFERRED EMBODIMENT

43. Turning now descriptively to the drawings, in which similar reference characters denote similar elements throughout the several views, FIGS. 1 through 10 illustrate a post protection system 10, which comprises an elongate sleeve 20 having a plurality of side walls 22, an upper opening 21, a floor 26 and an interior cavity 28. A plurality of vertical ribs 24 extend inwardly from the side walls 22 toward the interior cavity 28 for engaging the outside surface of the wooden post 12. A seal 40 is positionable about the upper end of the sleeve 20 for enclosing the upper opening 21 with the wooden post 12 positioned within. Ventilation into the interior cavity 28 is allowed about the lower end of the seal 40 through the grooves created by the vertical ribs 24 while still allowing the seal 40 to prevent rain from entering the upper portion thereof. A plurality of extended members 30 extend from the lower portion of the sleeve 20 for retaining the sleeve 20 properly positioned during ground freezing and various other conditions that tend to apply an upward force upon the sleeve 20.

44. As shown in FIGS. 1, 2, 4, 5, 6 and 8 of the drawings, wooden posts 12 are an elongated structure generally comprised of a square or rectangular shaped cross sectional area. Wooden poles are generally comprised of a circular cross sectional area which is not shown within the present application. The present application may be utilized with either wooden posts 12 or wooden poles depending upon the application required. Wooden posts 12 and poles are often times utilized to construct building structure such as pole barns or the like. There are various other applications for wooden posts 12 and poles. In addition to receiving wooden posts 12 and poles, the present invention is capable of receiving non-wooden posts 12 and poles as can be appreciated. Also, the length of the sleeve 20 is preferably shorter than the overall length of the post 12.

45. As best shown in FIGS. 2 through 4 of the drawings, the elongate sleeve 20 is a tubular structure preferably have a square or rectangular cross sectional area for receiving the wooden post 12. However it can be appreciated that the elongate sleeve 20 may be constructed to form a circular cross sectional shape to receive a wooden pole or other structures. The elongate sleeve 20 may be constructed of various types of materials such as but not limited to metal, plastic, fiberglass or other materials. The elongate sleeve 20 may be constructed utilizing various construction methods such as but not limited to blow molding, rotational molding and injection molding. The elongate sleeve 20 is preferably constructed to be impermeable to air or water except through the upper opening 21.

46. The elongate sleeve 20 has at least one side wall 22, an upper opening 21, a floor 26 and an elongate interior cavity 28 as shown in FIGS. 1 through 9 of the drawings. The elongate sleeve 20 is preferably comprised of four side walls 22 forming a square or rectangular cross sectional shape as best shown in FIGS. 5, 6, 7 and 9 of the drawings. The interior cavity 28 of the sleeve 20 is preferably larger than the post 12 thereby defining a space in between as best shown in FIGS. 5 and 6 of the drawings. The interior cavity 28 is formed to adequately receive the wooden post 12 without providing significant resistance to the post 12 during insertion. The lower corners 29 of the sleeve 20 where the floor 26 and the side walls 22 are adjoined are preferably rounded to provide centering of the lower end of the wooden post 12 within the interior cavity 28 of the sleeve 20 as best shown in FIGS. 1, 2, 3, 4 and 8 of the drawings.

47. As shown in FIGS. 2 and 3 of the drawings, a plurality of dimples 23 or apertures are preferably positioned within the upper portion of the side walls 22 of the sleeve 20 for receiving a corresponding plurality of fasteners 14 such as nails thereby securing the wooden post 12 within the sleeve 20 to prevent accidental removal of the post 12 from the sleeve 20. The dimples 23 or apertures provide guidance for the user to insert the fasteners 14 through the sleeve 20 into the wooden post 12. As shown in FIG. 1 of the drawings, when the seal 40 is properly positioned about the sleeve 20 and the post 12, the fasteners 14 are completely covered by the seal 40 to prevent seepage of water into the interior cavity 28 of the sleeve 20.

48. As shown in FIGS. 1 through 9 of the drawings, a plurality of vertical ribs 24 extend inwardly from the side walls 22 of the elongate sleeve 20 toward the interior cavity 28 for engaging and supporting the side portions of the post 12 positioned within the sleeve 20. The vertical ribs 24 are preferably substantially parallel to the longitudinal axis of the sleeve 20 and the wooden post 12 as best shown in FIGS. 1, 2, 3, 4 and 8 of the drawings.

49. There are preferably two vertical ribs 24 upon each of the side walls 22 as best shown in FIGS. 5 through 7 of the drawings. However, various number combinations of vertical ribs 24 per each of the side walls 22 may be utilized to provide stability to the wooden post 12 within. The vertical ribs 24 are preferably concave shaped extending into the interior cavity 28 and are preferably compressible for receiving a wooden post 12 of larger size. The vertical ribs 24 may have various other cross sectional shapes. Each of the vertical ribs 24 also forms a vertical vent within the exterior surface of the sleeve 20 that allows ventilation of the post 12 and interior cavity 28 underneath the seal 40.

50. As shown in FIGS. 2, 3, 4, 5, 7 and 9 of the drawings, a plurality of extended members 30 preferably extend outwardly from a lower portion of the sleeve 20 for providing resistance to vertical uplift of the sleeve 20 when positioned within the ground. The extended members 30 are preferably tapered having a pointed end 32 as best shown in FIG. 4 of the drawings. There are preferably a pair of extended members 30 extending from the sleeve 20 on opposing sides thereof as best shown in FIGS. 2, 3, 4, 5 and 7 of the drawings. However, it can be appreciated that an increased number of extended members 30 may be utilized as shown in FIG. 9 of the drawings. It can also be appreciated that the extended members 30 may be comprised of various shapes and sizes.

51. As shown in FIGS. 1 through 6 of the drawings, a seal 40 is provided to form a water resistant seal about the outer surface of the wooden post 12 adjacent the upper opening 21 of the sleeve 20 to prevent water from entering the upper opening 21 and interior cavity 28 of the sleeve 20. The seal 40 is preferably constructed of a resilient and stretchable material such as rubber to allow conforming to the shape and texture of the wooden post 12 and the sleeve 20. The seal 40 is formed to tightly surround the outer surface of the sleeve 20 and the outer surface of the wooden post 12 as best illustrated in FIGS. 1, 4, 6 and 8 of the drawings. The seal 40 may have various heights as long as a portion of the sleeve 20 and the wooden post 12 are both engagable as shown in FIG. 1 of the drawings.

52. In use, the user positions the seal 40 about the upper end of the sleeve 20 below the dimples 23 or apertures within the sleeve 20 as shown in FIG. 2 of the drawings. The user then inserts the wooden post 12 into the upper opening 21 of the sleeve 20 and manual extends the wooden post 12 downwardly into the interior cavity 28 of the sleeve 20. If the post 12 is larger in size than the conventional post 12, the vertical ribs 24 are compressed thereby allowing proper insertion of the post 12 without causing binding problems. The post 12 is fully inserted into the sleeve 20 when the lower end of the post 12 is engaged to the rounded corners 29 of the sleeve 20 thereby assuring proper seating of the wooden post 12 within the sleeve 20. The user then secures one or more fasteners 14 through the dimples 23 or apertures into the wooden post 12 to secure the wooden post 12 within the sleeve 20. After the fasteners 14 are properly inserted, the user then slides the seal 40 upwardly upon a portion of the wooden post 12 and the sleeve 20 as best shown in FIGS. 1 and 4 of the drawings. The seal 40 is preferably positioned so as to at least completely cover the fasteners 14 and the upper opening 21 exposed between the side walls 22 and the post 12. The seal 40 prevents water and debris from entering the interior cavity 28 of the sleeve 20 as best illustrated within FIG. 8 of the drawings. In addition, the vertical vents formed by the vertical ribs 24 allow air to flow through the vertical vents underneath the seal 40 to provide ventilation to the interior cavity 28 of the sleeve 20 as further shown in FIG. 8 of the drawings. The sleeve 20 and post 12 are then positioned within the ground with a portion of the post 12 above the ground covered by the sleeve 20 as shown in FIGS. 1 and 4 of the drawings. The extended members 30 extending from the sleeve 20 prevent the sleeve 20 and the post 12 from being accidentally elevated from the ground by undesirable forces such as ground freezing or wind.

53. As to a further discussion of the manner of usage and operation of the present invention, the same should be apparent from the above description. Accordingly, no further discussion relating to the manner of usage and operation will be provided.

54. With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

55. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A post protection system for receiving and protecting a lower portion of a post when inserted into ground, comprising:
a sleeve having at least one side wall, a floor, and an upper opening exposing an interior cavity; and
a plurality of vertical ribs extending inwardly from said at least one side wall toward said interior cavity for engaging said post inserted within said sleeve.

2. The post protection system of claim 1, wherein said plurality of vertical ribs are compressible for allowing various sizes of said post to be positioned within said sleeve.

3. The post protection system of claim 2, wherein each of said plurality of vertical ribs have a concave cross sectional shape.

4. The post protection system of claim 3, wherein said floor and said at least one side wall form a junction, wherein said junction is curved for centering a lower end of said post within said sleeve.

5. The post protection system of claim 4, wherein said at least one side wall is comprised of four side walls.

6. The post protection system of claim 5, wherein each of said four side walls has at least one of said plurality of vertical ribs.

7. The post protection system of claim 6, wherein each of said four side walls has at least a pair of said plurality of vertical ribs, wherein each said pair of vertical ribs is parallel to one another.

8. The post protection system of claim 7, including a plurality of extended members extending outwardly from a lower portion of said sleeve for engaging said ground, wherein said plurality of extended members are tapered outwardly having a pointed end.

9. The post protection system of claim 8, wherein said sleeve has a square shaped cross sectional area.

10. The post protection system of claim 8, wherein said sleeve has a rectangular shaped cross sectional area.

11. A post protection system for receiving and protecting a lower portion of a post when inserted into ground, comprising:
a sleeve having at least one side wall, a floor, and an upper opening exposing an interior cavity; and
a seal constructed of a resilient material, wherein said seal is formed to snugly fit about an outer surface of said sleeve and said post adjacent said upper opening for preventing water from entering said upper opening of said sleeve.

12. The post protection system of claim 11, a plurality of vertical ribs extending inwardly from said at least one side wall toward said interior cavity for engaging said post inserted within said sleeve, wherein said plurality of vertical ribs are compressible for allowing various sizes of said post to be positioned within said sleeve.

13. The post protection system of claim 12, wherein each of said plurality of vertical ribs have a concave cross sectional shape each forming a vertical vent for allowing air to flow through said vertical vent into said seal without water entering.

14. The post protection system of claim 13, wherein said floor and said at least one side wall form a junction, wherein said junction is curved for centering a lower end of said post within said sleeve.

15. The post protection system of claim 14, wherein said at least one side wall is comprised of four side walls.

16. The post protection system of claim 15, wherein said seal is constructed of a rubber material.

17. The post protection system of claim 16, wherein each of said four side walls has at least a pair of said plurality of vertical ribs, wherein each said pair of vertical ribs is parallel to one another.

18. The post protection system of claim 17, including a plurality of extended members extending outwardly from a lower portion of said sleeve for engaging said ground, wherein said plurality of extended members are tapered outwardly having a pointed end.

19. The post protection system of claim 18, wherein said sleeve includes a plurality of dimples formed within an upper portion of said sleeve for receiving a corresponding plurality of fasteners, wherein said seal covers said fasteners and said dimples when positioned upon said sleeve and said post.

20. A method of utilizing a post protection system for protecting a lower portion of a wooden post, said post protection system having a tubular sleeve with an upper opening, four side walls having a plurality of vertical ribs extending inwardly having a concave shape, and a stretchable seal, comprising the steps of:
(a) positioning said stretchable seal about an upper portion of said sleeve adjacent said upper opening;
(b) positioning a lower end of said wooden post adjacent said lower opening of said sleeve;
(c) extending said wooden post into said sleeve with an outer surface of said wooden post engaging said plurality of vertical ribs and compressing said plurality of vertical ribs;
(d) continuing extending said wooden post into said sleeve until said lower end of said wooden post engages said floor of said sleeve; and
(e) sliding said stretchable seal upwardly upon said sleeve until said stretchable seal is engaging said wooden post and said sleeve.
